(19) United States
(12) Patent Application Publication
(10) Pub. No.: US 2008/0276194 A1
(43) Pub. Date: Nov. 6, 2008

(54) METHOD OF EXPOSING FULLY EDITABLE TEXT FIELDS ON A MOBILE DEVICE

(75) Inventors: Elizabeth Dykstra-Erickson, San Francisco, CA (US); Hiroyuki Toki, San Jose, CA (US); Alison Mettler, Arroyo Grande, CA (US)

Correspondence Address: BERRY & ASSOCIATES P.C., 9255 SUNSET BOULEVARD, SUITE 810, LOS ANGELES, CA, 90069, US

(73) Assignee: ACCESS SYSTEMS AMERICAS, INC., Sunnyvale, CA (US)

(21) Appl. No.: 12/026,544

(22) Filed: Feb. 5, 2008

Related U.S. Application Data
(60) Provisional application No. 60/888,539, filed on Feb. 6, 2007.

(51) Int. Cl. G06F 3/048

(52) U.S. Cl. 715/780

(57) ABSTRACT

A method for fully exposing fully editable text fields on a mobile device is disclosed. The text fields are configured for flags where the flags indicate the type of content stored in the text fields. The method includes assigning a third flag to a disclose property where the disclose property configures the display of editable text in the text field and exposing the text fields according to the third flag.

This application claims priority from U.S. provisional patent application No. 60/888,539, filed Feb. 6, 2007, having common inventors and a common assignee with the present application, the disclosure of which is hereby incorporated by reference in its entirety.

### BACKGROUND OF THE INVENTION

The present invention generally relates to a method for exposing the fully editable text fields on a limited screen mobile device, and more particularly to a method for using field flags to indicate exposure options for exposing the full contents of editable text input fields.

Text input fields on mobile devices can consist of single-line entry or multiple-line entry. Oftentimes, the text entry field can often be much smaller than the number of characters that it may hold; that is, the visible field does not always expose everything that is in it, as the character limit is generally independent of the field's ability to completely display a string. Not only can more text be entered than is visible; even when text is entirely visible, a change to the font size or the layout of the input form can make a difference in what is or is not visible. Therefore, users must in many cases navigate within the text to be able to read it in its entirety.

Several methods are available to clip text when the text does not fit fully exposed in a text edit field. Truncation and elision are two methods used to clip text when it does not fit fully exposed in a text edit field. Using an ellipsis at the end of clipped text is the typical method to inform the user that more text exists which they can't view until they take an action (such as entering the field and scrolling) to do so. Accessing that text generally requires more input steps from the user. Where an ellipsis is not visible, the user may not recognize that all text is not exposed; and where an ellipsis is not familiar to the user, the three dots that form the ellipsis, are a meaningless clue.

Further, some contexts (arrangement of text entry fields, proximity to other controls on the screen, or screen dimensions/orientation) can take better advantage of some text disclosure methods than others. The visibility of editable text strings varies with different contexts, making it difficult for users to read, requiring additional navigation steps. Many methods exist to expose hidden text that are hard-coded. There is no systematic way to declare a global disclosure method, and alternatives to the standard behaviors must be individually hard-coded.

These and other advantages may be provided by various embodiments of the present invention.

### SUMMARY OF THE INVENTION

The present invention provides a method for controlling how the contents of a text field are displayed on a mobile device, the mobile device having a physical display for displaying at least one text field. A disclosure flag is provided for the text field, the disclosure flag specifying one of a predetermined set of disclosure methods for how text exceeding the size of an initial physical display area will be displayed. The contents of the text field that exceed the size of the initial physical display area are displayed according to the method specified in the disclosure flag.

In some instances, one of the disclosure methods is a default method wherein when the text field is selected, the size of the initial physical display area expands up to a predetermined limit, and remains at its expanded size after the text field is de-selected.

In some instances, one of the disclosure methods is an accordion method wherein when the text field is selected, the initial physical display area expands to reveal all input text, and returns to its original size after the text field is de-selected.

In some instances, one of the disclosure methods is a crawling method wherein when the text field is selected, the contents of the field are shifted horizontally in the initial physical display area until all of the contents have been made visible.

In some instances, one of the disclosure methods is a sublaunch method wherein when the text field is selected, the initial physical display area expands to a larger area enabling vertical scrolling.

In some instances, one of the disclosure methods is a zoom rectangle method wherein when the text field is selected, the initial physical display area expands to occupy the entire physical display.

In some instances, one of the disclosure methods is a multistage method wherein when contents of the text field exceed the size of the initial physical display area, a first action button appears inside the initial physical display area, when the first action button is selected, the initial physical display area expands to a first expanded physical display area having a second action button when the contents of the text field exceed the size of the first expanded physical display area, and when the second action button is selected, the first expanded physical display area expands to a second expanded physical display area that is larger than the first expanded physical display area.

The present invention also provides a method for controlling how the contents of a text field are displayed on a mobile device, the mobile device having a physical display for displaying at least one text field. A global style record is provided for the text field, the global style record including a disclosure flag specifying one of a predetermined set of disclosure methods for how text exceeding the size of an initial physical display area will be displayed, and the contents of the text field that exceed the size of the initial physical display area are displayed according to the method specified in the disclosure flag.

The present invention further provides a method for controlling how the contents of a text field are displayed on a device having a physical display. A disclosure method is selected from a predetermined set of disclosure methods for how text exceeding the size of an initial physical display area will be displayed, and a disclosure flag for the text field is set to the selected disclosure method.

Additional features and advantages of the invention will be set forth in the description which follows, and in part will be obvious from the description, or may be learned by practice of the invention.

### BRIEF DESCRIPTION OF THE DRAWINGS

The invention is further described in the detailed description that follows, by reference to the noted drawings by way of non-limiting illustrative embodiments of the invention, in which like reference numerals represent similar parts throughout the drawings. As should be understood, however, the invention is not limited to the precise arrangements and instrumentalities shown. In the drawings:

FIGS. 1A-1C are screen displays illustrating the Default method for disclosing text fields;

FIGS. 2A-2D are screen displays illustrating the Accordion method for disclosing text fields;

FIGS. 3A-3D are screen displays illustrating the Crawling method for disclosing text fields;

FIGS. 4A-4D are screen displays illustrating the Sublaunch method for disclosing text fields;

FIGS. 5A-5C are screen displays illustrating the Zoom Rectangle method for disclosing text fields;

FIG. 6 is a screen display illustrating an action button inside a text field; and

FIGS. 7A-7D are screen displays illustrating the Multistage method for disclosing text fields.

### DETAILED DESCRIPTION

In the following description, for purposes of explanation and not limitation, specific details are set forth, such as particular networks, communication systems, computers, terminals, devices, components, techniques, data and network protocols, software products and systems, operating systems, development interfaces, hardware, etc. in order to provide a thorough understanding of the present invention.

However, it will be apparent to one skilled in the art that the present invention may be practiced in other embodiments that depart from these specific details. Detailed descriptions of well-known networks, communication systems, computers, terminals, devices, components, techniques, data and network protocols, software products and systems, operating systems, development interfaces, and hardware are omitted so as not to obscure the description of the present invention.

In order to reduce the time and effort of scrolling/navigating through many fields of varying lengths in order to allow the user to see more of the options contained on the screen, a mechanism is needed that will allow the user to collapse and easily skip over information that is not of interest, such as multiple lines of the same text entry field.

However, a single solution is not always contextually relevant. Therefore, a flexible mechanism for assigning a disclosure method is useful for helping the software developer apply specific contextually relevant behaviors.

GTK is a library for creating graphical user interfaces. The acronym stands for GNU Image Manipulation Program (GIMP) Toolkit. More information about GTK is available at www.gtk.org. One embodiment of the present invention will now be described with reference to GTK.

GTK+ has a “GtkTextTag”, a tag that can be applied to text in a GtkTextBuffer. One of the “properties” of the GtkTextTag is “wrap-mode” which controls whether a line is allowed to wrap. See http://library.gnome.org/devel/gtk/stable/GtkTextTag.html.

GTK+ has a “GtkEntry” single line text entry field. One of the “properties” of the GtkEntry is “scroll-offset” which keeps track of how many pixels of text being entered have scrolled to the left as a user is entering text; the developer can then use the value of scroll offset in subsequent program activity. See http://library.gnome.org/devel/gtk/2.11/GtkEntry.html.

Neither of the above-described mechanisms is a flag that enables a developer to select from a predetermined set of methods for displaying text exceeding the size of an initial physical display area.

Generally, a software developer can “flag” a field for the type of characters it will accept, and for the input method. Characters refers to numbers, letters, and symbols, such as symbols used in an equation editor. Input method refers to different techniques for a user to indicate a desired character, such as hard keypad, soft keypad indicated by stroke characters—sometimes referred to as graffiti software, soft keypad indicated by cubes that expand and enable the user to lift their stylus on the desired letter, and so on. Table 1 shows an example of a text field followed by its two associated flags.

TABLE 1

| | | |
|---|---|---|
| Text Field | Flag: Character type | Flag: Input method |

The concept of additional flags exists in GTK. Therefore, extending the number of flags and the behaviors they elicit is an area of opportunity.

A third flag is added relating to how text that exceeds the size of an initial physical display area for the field is to be revealed to the user; this flag is referred to as a disclosure flag. The disclosure flag enables program developers to specify how an input field adjusts itself to display more text than fits in a screen window. The third flag permits the developer to choose from a number of predefined disclosure methods, increasing the flexibility of the display across many different devices, and helping to ensure a better user experience.

A fourth flag is added for soft keypad mode, enabling the program developer to specify further characteristics of the characters, such as lowercase, uppercase, mixed case, sentence case, numeric.

Table 2 shows an example of a single text field followed by associated flags, including the disclosure flag and the soft keypad mode flag.

TABLE 2

| | | | | |
|---|---|---|---|---|
| Text Field | Flag: Character type | Flag: Input method | Flag: Disclosure | Flag: SK mode |

A flexible mechanism for setting both individually (a single field at a time) and globally (all fields in a defined context) the multiple-line text edit disclosure benefits the developer because the developer can select from among existing options rather than having to independently develop options. Selecting from existing options is faster and less work than developing options. The flexible mechanism is advantageous to the user as it is a familiar interface across different applications, obviating the need for the user to learn separate techniques for disclosing text in different applications.

The software developer sets the disclosure flag for a field to one of a predetermined set of methods for displaying text that exceeds what can be displayed on a device's display field. For example, the disclosure flag can be set to one of

| | |
|---|---|
| D | Default method |
| A | Accordion method |
| C | Crawling method |
| S | Sublaunch method |
| Z | Zoom rectangle method |
| U | Sublaunch action method |
| O | Zoom rectangle action method |
| M | Multistage method |

These methods are described below.

Table 3 shows an exemplary set of single text field flags specified by a programmer, indicating that the input field is alphanumeric (“an”), the input method is soft keypad with stroke characters (“SKS”), the disclosure method is Zoom Rectangle (“Z”), and the soft keypad mode is sentence case (“S”).

TABLE 3

| | | | | |
|---|---|---|---|---|
| Text Field | character type = an | input method = SKS | disclosure = Z | SK mode = S |

Table 4 shows an example of setting multiple-line text disclosures globally. A style record represents a predefined set of flags. Individual text fields specify the style records instead of specifying the individual flags.

TABLE 4

| Style1 | character type = an | input method = SKS | disclosure = Z | SK mode = S |
|---|---|---|---|---|
| Style2 | character type = n | input method = SKS | disclosure = C | SK mode = S |
| TextField1 | Style1 | | | |
| TextField2 | Style2 | | | |
| TextField3 | Style1 | | | |
| TextField4 | character type = a | input method = SKS | disclosure = M | SK mode = S |

More specifically, Table 4 shows two style records, “Style1” and “Style2”, and four text fields, “TextField1”, “TextField2”, “TextField3” and “TextField4”. TextField1 and TextField3 have their flag settings determined by the Style1 record. TextField2 has its flag settings determined by the Style2 record. TextField4 has its flag settings individually specified, in a similar manner as shown in Table 3.

Text disclosure methods will now be discussed.

In the Default method, all text is exposed. The empty field takes one line on the form, but grows as the field length limit permits. If the user types three lines of text, three lines of text are exposed. When the field is exited, the three typed lines remain exposed.

In the following, a field is selected by any suitable technique, such as moving a cursor up and down, touching the field with a stylus, and so on.

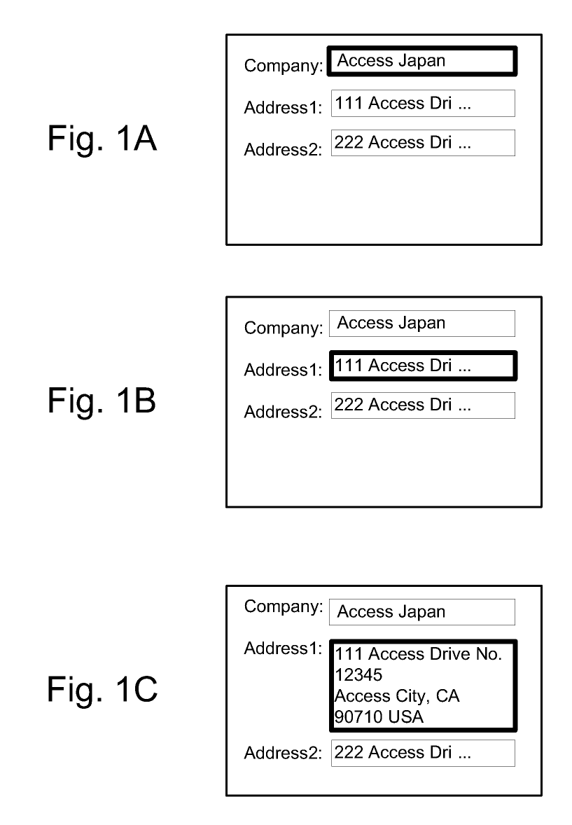

FIG. 1A shows a typical screen display having three lines of information, labeled “Company”, “Address1” and “Address2”. In FIG. 1A, the first line is selected, as indicated by a heavy line around the contents of the field. Specifically, the field of the first line is “Company” and the contents of the field are “Access Japan”. Since there is no ellipsis at the end of the text, it is clear that all of the field's content is visible.

FIG. 1B shows the display of FIG. 1A, an instant after the second line is selected, as indicated by a heavy line around the contents of the field. Specifically, the field of the second line is “Address1” and the contents of the filed are “111 Access Dr”. Since there is an ellipsis ( . . . ) at the end of the text, it is clear that some of the field's content is not visible.

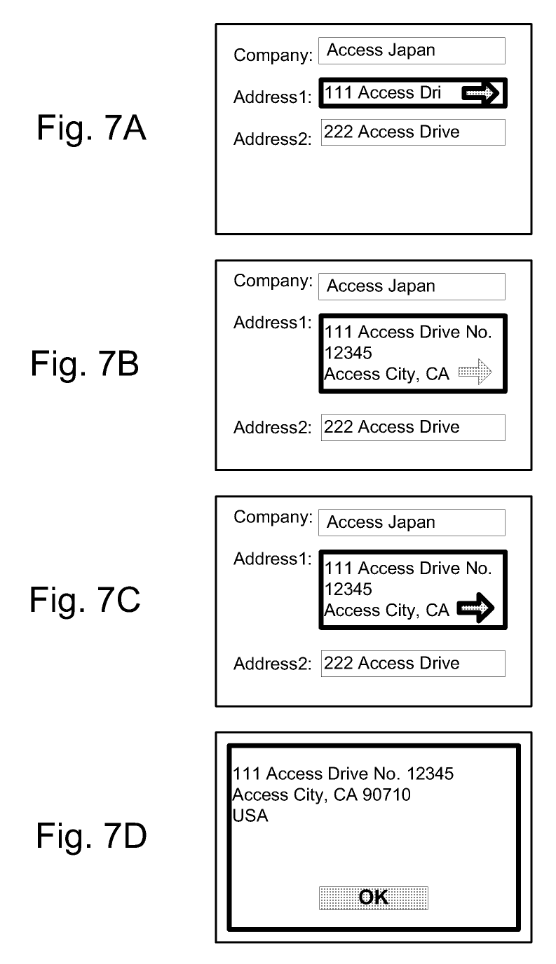

FIG. 1C shows the display of FIG. 1B after the second line has been selected for a predetermined amount of time sufficient to indicate that the user has indeed selected the line as opposed to just passing through it while moving the cursor vertically up or down, such as one second. Now, the field size of the second line expands to a sufficient number of lines to display the full contents of the field, if the number of lines needed for display is less than or equal to the available number of lines on the display. In the event that the number of lines needed for display is greater than the available number of lines on the display, then a suitable overflow handling methodology is used. In one case, the overflow methodology is to simply not permit display of the text exceeding the display size available. In another case, the overflow methodology is to enable use of up/down arrow keys to move the window created by the number of available lines along the full number of lines needed for display. A further case of overflow methodology is described below with reference to FIG. 7. Other overflow methodologies will be apparent to those of ordinary skill. As shown in FIG. 1C, the number of lines needed for display is equal to the available number of lines on the display, so the full contents of the field are visible:
111 Access Drive No. 12345
Access City, Calif. 90710 USA

When the user selects another line, the second line remains in its expanded configuration.

For the remainder of the methods, only one line is exposed until the field is entered. If there is more than one line of input text, then the method operates as described below.

In the Accordion method, when the field is entered, the field “unfolds” to reveal all input text. When the field is exited, the field “refolds” to its one-line state.

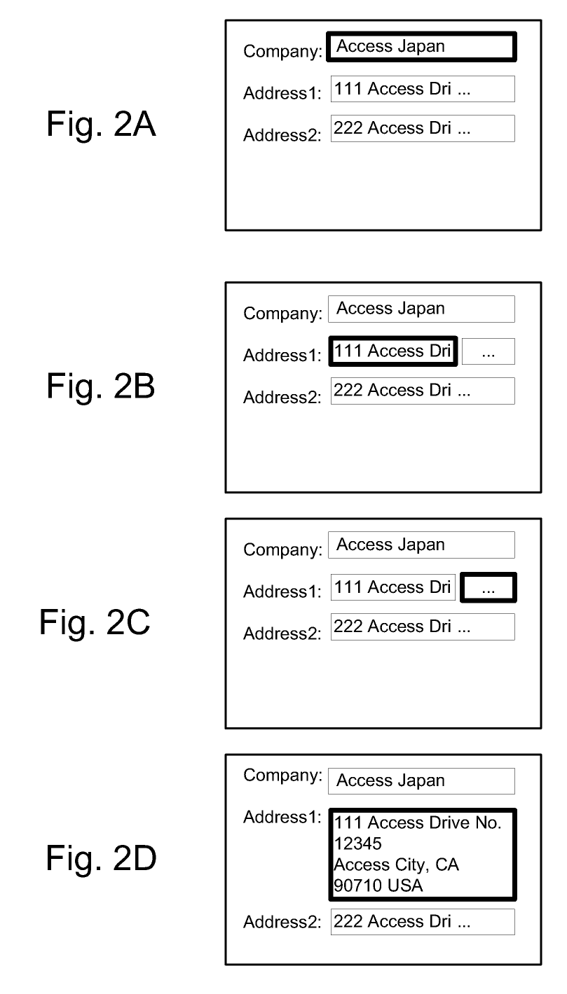

FIG. 2A is the same as FIG. 1A, and is repeated here for convenience.

FIG. 2B shows the display of FIG. 2A, an instant after the second line is selected, as indicated by a heavy line around the contents of the field. In the Accordion method, when the second line is selected, the display splits the field into a left portion for showing partial contents of the field, and a right portion showing an ellipsis, indicating that if the user wishes to see the rest of the field, the user should select the right portion.

FIG. 2C shows the display of FIG. 2B, an instant after the right portion is selected, as indicated by a heavy line around the ellipsis.

FIG. 2D is the same as FIG. 1C, and shows the display of FIG. 2C after the right portion has been selected for a predetermined amount of time sufficient to indicate that the user has indeed selected the right portion, as opposed to just moving the cursor through the right portion.

In the Crawling method, when the field is entered, based on an application-defined limit such as ‘if string length <3 lines when exposed,’ the text is shifted horizontally from right to left in the physical display area, so that the text appears to crawl, similar to the way a horizontal title crawls on video or broadcast television, to the end, stops, and can then be horizontally scrolled with the left/right arrow keys.

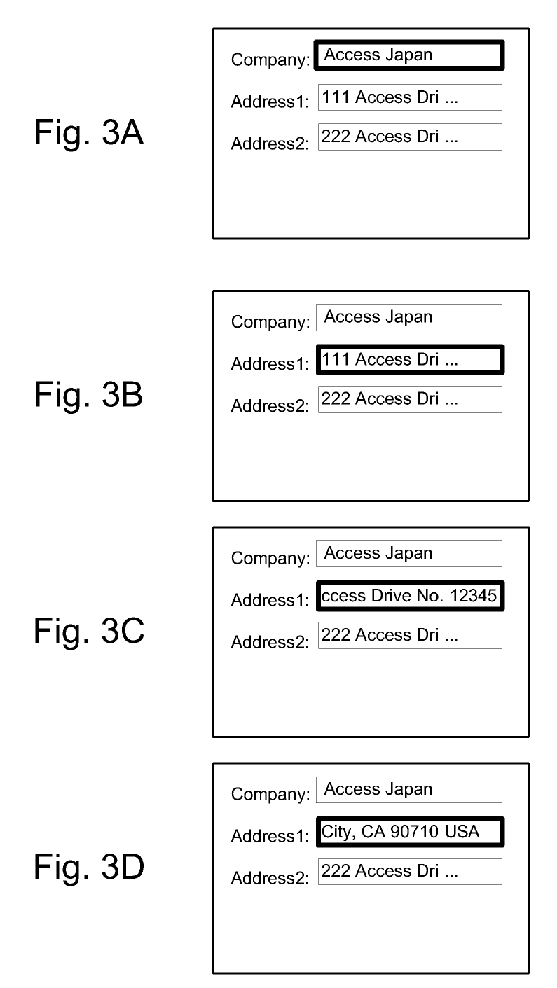

FIGS. 3A and 3B are the same as FIGS. 1A and 1B, and are repeated here for convenience.

FIG. 3C shows that the contents of the second line are now moving across the field, with new contents being displayed at the right side while already displayed contents “drop off” from the left side of the field.

FIG. 3D shows that the contents of the second line have stopped moving because the rightmost portion of the contents are displayed. The user now employs the left and right arrow keys on a keypad, or similar signals, to indicate that the contents of the second line should be moved within the display.

In the Sublaunch method, when the field is entered, the full text is exposed in a scrollable sublaunched dialog where it can be edited and vertically scrolled in full; the user dismisses the dialog with an explicit action (e.g., a button) and the display returns to the default state of the text edit field.

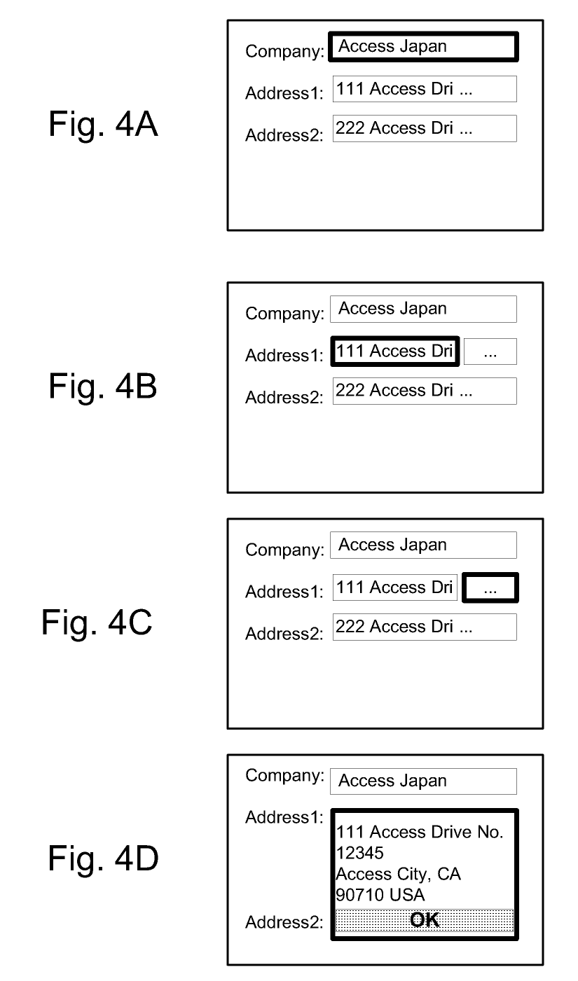

FIGS. 4A-4C are the same as FIGS. 2A-2C, and are repeated here for convenience.

FIG. 4D shows the display of FIG. 4C after the right portion has been selected for a predetermined amount of time sufficient to indicate that the user has indeed selected the right portion, as opposed to just moving the cursor through the right portion. The size of the second line field has now expanded to occlude the third line field. The second line field shows the full contents, and has a horizontal bar serving as an action button, indicated by shading, at the bottom of the field. The horizontal bar can be selected separately by the user; when the user selects the horizontal bar, the display returns to the configuration of FIG. 4C.

In the Zoom Rectangle method, when the field is entered, the edit field animates larger to take over the screen, revealing the full text and temporarily obscuring the form beneath it. When the form is exited via an explicit user action (e.g., pressing a button), the zoom rectangle recedes back into the form and returns to the one-line view.

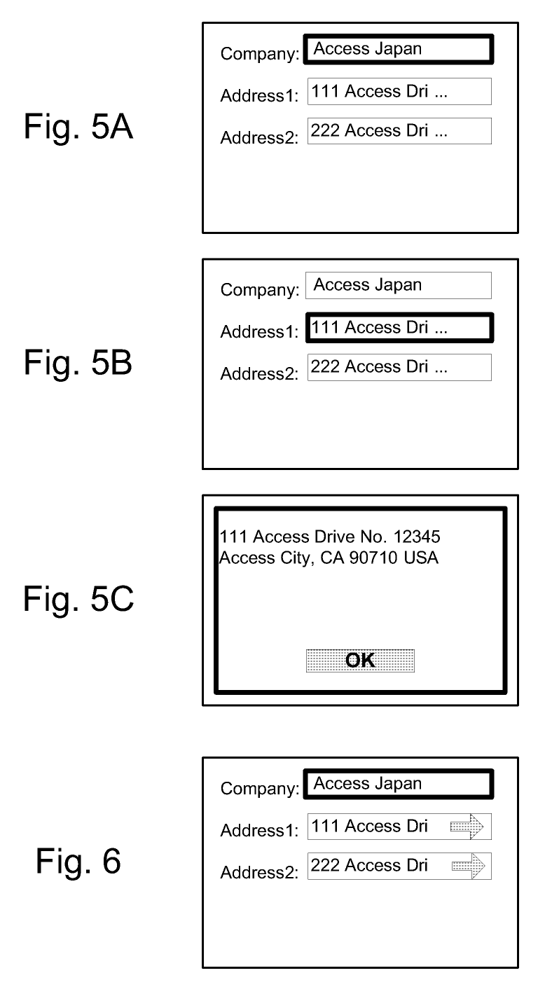

FIGS. 5A and 5B are the same as FIGS. 1A and 1B, and are repeated here for convenience.

FIG. 5C shows the display of FIG. 5B after the second line has been selected for a predetermined amount of time sufficient to indicate that the user has indeed selected the line as opposed to just passing through it while moving the cursor vertically up or down, such as one second. Now, the field size of the second line expands to the size of the entire display. When the user is finished viewing the information, the user clicks on the shaded action button, and the display returns to the configuration of FIG. 5B.

FIG. 6 shows an action button, a shaded arrow, placed inside the text edit field to indicate “more” in the second and third fields. When the user actuates the action button, the contents of the field are disclosed, in the Sublaunch Action method if the contents are displayed as in the Sublaunch method, or in the Zoom Rectangle Action method if the contents are displayed as in the Zoom Rectangle method.

In the Multistage method for viewing the contents of a field, when the contents of a field exceed the available display size on a screen, a first action button appears at the end of the field; when the user actuates the first action button, the field expands to a first predetermined size, such as three lines. If there is still undisplayed text in the expanded field, then a second action button appears at the end of the text; when the user actuates the second action button, the field expands to the full size of the display as in the Zoom Rectangle method. If there is still undisplayed text in the full screen display, then a suitable overflow handling methodology is used, as discussed above.

FIG. 7A is similar to FIG. 6 except that only the second line has an embedded action button, and shows actuation of the first action button for the second line of the display.

FIG. 7B shows the first expansion of the second line of the display.

FIG. 7C shows actuation of the second action button for the first expansion.

FIG. 7D shows the second expansion of the second line of the display. The expansion includes an action button that, when actuated, returns the display to being as shown in FIG. 7B with the first action button being unactuated.

It is to be understood that the foregoing illustrative embodiments have been provided merely for the purpose of explanation and are in no way to be construed as limiting of the invention. Words used herein are words of description and illustration, rather than words of limitation. In addition, the advantages and objectives described herein may not be realized by each and every embodiment practicing the present invention. Further, although the invention has been described herein with reference to particular structure, materials and/or embodiments, the invention is not intended to be limited to the particulars disclosed herein. Rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention.

What is claimed is:

1. A method for controlling how the contents of a text field are displayed on a mobile device, the mobile device having a physical display for displaying at least one text field, comprising:
providing a disclosure flag for the text field, the disclosure flag specifying one of a predetermined set of disclosure methods for how text exceeding the size of an initial physical display area will be displayed, and
displaying the contents of the text field that exceed the size of the initial physical display area according to the method specified in the disclosure flag.

2. The method of claim 1, wherein one of the disclosure methods is a default method wherein when the text field is selected, the size of the initial physical display area expands up to a predetermined limit, and remains at its expanded size after the text field is de-selected.

3. The method of claim 1, wherein one of the disclosure methods is an accordion method wherein when the text field is selected, the initial physical display area expands to reveal all input text, and returns to its original size after the text field is de-selected.

4. The method of claim 1, wherein one of the disclosure methods is a crawling method wherein when the text field is selected, the contents of the field are shifted horizontally in the initial physical display area until all of the contents have been made visible.

5. The method of claim 1, wherein one of the disclosure methods is a sublaunch method wherein when the text field is selected, the initial physical display area expands to a larger area enabling vertical scrolling.

6. The method of claim 1, wherein one of the disclosure methods is a zoom rectangle method wherein when the text field is selected, the initial physical display area expands to occupy the entire physical display.

7. The method of claim 1, wherein one of the disclosure methods is a multistage method wherein
when contents of the text field exceed the size of the initial physical display area, a first action button appears inside the initial physical display area,
when the first action button is selected, the initial physical display area expands to a first expanded physical display area having a second action button when the contents of the text field exceed the size of the first expanded physical display area, and
when the second action button is selected, the first expanded physical display area expands to a second expanded physical display area that is larger than the first expanded physical display area.

8. A method for controlling how the contents of a text field are displayed on a mobile device, the mobile device having a physical display for displaying at least one text field, comprising:
providing a global style record for the text field, the global style record including a disclosure flag specifying one of a predetermined set of disclosure methods for how text exceeding the size of an initial physical display area will be displayed, and
displaying the contents of the text field that exceed the size of the initial physical display area according to the method specified in the disclosure flag.

9. The method of claim 8, wherein one of the disclosure methods is a default method wherein when the text field is selected, the size of the initial physical display area expands up to a predetermined limit, and remains at its expanded size after the text field is de-selected.

10. The method of claim 8, wherein one of the disclosure methods is an accordion method wherein when the text field is selected, the initial physical display area expands to reveal all input text, and returns to its original size after the text field is de-selected.

11. The method of claim 8, wherein one of the disclosure methods is a crawling method wherein when the text field is selected, the contents of the field are shifted horizontally in the initial physical display area until all of the contents have been made visible.

12. The method of claim 8, wherein one of the disclosure methods is a sublaunch method wherein when the text field is selected, the initial physical display area expands to a larger area enabling vertical scrolling.

13. The method of claim 8, wherein one of the disclosure methods is a zoom rectangle method wherein when the text field is selected, the initial physical display area expands to occupy the entire physical display.

14. The method of claim 8, wherein one of the disclosure methods is a multistage method wherein
when contents of the text field exceed the size of the initial physical display area, a first action button appears inside the initial physical display area,
when the first action button is selected, the initial physical display area expands to a first expanded physical display area having a second action button when the contents of the text field exceed the size of the first expanded physical display area, and
when the second action button is selected, the first expanded physical display area expands to a second expanded physical display area that is larger than the first expanded physical display area.

15. A method for controlling how the contents of a text field are displayed on a device having a physical display, comprising:
selecting a disclosure method from a predetermined set of disclosure methods for how text exceeding the size of an initial physical display area will be displayed, and
setting a disclosure flag for the text field to the selected disclosure method.

16. The method of claim 15, wherein one of the disclosure methods is a default method wherein when the text field is selected, the size of the initial physical display area expands up to a predetermined limit, and remains at its expanded size after the text field is de-selected.

17. The method of claim 15, wherein one of the disclosure methods is an accordion method wherein when the text field is selected, the initial physical display area expands to reveal all input text, and returns to its original size after the text field is de-selected.

18. The method of claim 15, wherein one of the disclosure methods is a crawling method wherein when the text field is selected, the contents of the field are shifted horizontally in the initial physical display area until all of the contents have been made visible.

19. The method of claim 15, wherein one of the disclosure methods is a sublaunch method wherein when the text field is selected, the initial physical display area expands to a larger area enabling vertical scrolling.

20. The method of claim 15, wherein one of the disclosure methods is a zoom rectangle method wherein when the text field is selected, the initial physical display area expands to occupy the entire physical display.

21. The method of claim 15, wherein one of the disclosure methods is a multistage method wherein
when contents of the text field exceed the size of the initial physical display area, a first action button appears inside the initial physical display area,
when the first action button is selected, the initial physical display area expands to a first expanded physical display area having a second action button when the contents of the text field exceed the size of the first expanded physical display area, and
when the second action button is selected, the first expanded physical display area expands to a second expanded physical display area that is larger than the first expanded physical display area.
